(19) United States
(12) Patent Application Publication
(10) Pub. No.: US 2007/0110011 A1
(43) Pub. Date: May 17, 2007

(54) Mobile communication apparatus for operation in a wireless local area network

(76) Inventor: Joakim Nelson, Lund (SE)

Correspondence Address: MYERS BIGEL SIBLEY & SAJOVEC, PO BOX 37428, RALEIGH, NC, 27627, US

(21) Appl. No.: 11/272,606

(22) Filed: Nov. 14, 2005

(51) Int. Cl. H04Q 7/24

(52) U.S. Cl. 370/338

(57) ABSTRACT

A mobile communication apparatus and methods for operation in a wireless local area network. The mobile communication apparatus is equipped with a transceiver for communication of data intended for the mobile communication apparatus. Furthermore, the mobile communication apparatus comprises a repeater. The repeater is adapted to receive a data packet received by the transceiver, wherein the data packet is intended for another communication device, and forward the data packet via the transceiver to the communication device. Providing a repeater in the mobile communication apparatus may allow for the first communication device to connect wirelessly to the second communication device via the mobile communication apparatus, even though the first and the second communication devices are out-of-range for direct communication.

### TECHNICAL FIELD OF THE INVENTION

The present invention relates to a mobile communication apparatus and a method for operation in a wireless local area network.

### DESCRIPTION OF RELATED ART

Many standard protocols for short-range wireless communication in e.g. wireless local area networks (WLAN) are becoming popular. These standard protocols may include protocols such as IEEE 802.11, home RF, Bluetooth, etc. These protocols provide requirements for devices to communicate wirelessly within a local area network. For example, a wireless local area network may be based on a cellular architecture sub-divided into so-called Basic Service Sets (BSS), where each BSS is controlled by an Access Point (AP). The AP may be connected to a Distribution System (DS), which could e.g. be the Ethernet standard IEEE 802.3.

Furthermore, it is becoming more and more popular to provide a portable device, such as a mobile telephone or a portable computer, with a WLAN transceiver. Portable devices may, for example, communicate with each other within the wireless local area network according to any of the above-mentioned protocols, e.g. IEEE 802.11, home RF, Bluetooth. Furthermore, a portable device may communicate with a wired network via an AP of the wireless local area network. The maximum transmission length in a wireless local area network may be limited to a range of approximately 10 to 15 meters. Also, the maximum transmission length may in some cases be even more limited when the portable device has a limited output power, such as a mobile telephone. The above-mentioned range is, however, generally less than the coverage range required in places where the WLAN technology is to be utilized. These places include e.g. home environments, office environments and public places such as hotels, cafes, airport lounges, university campuses, etc. As distances in the area of coverage increase, the wireless system performance typically decreases.

### SUMMARY OF THE INVENTION

According to a first aspect, a mobile communication apparatus for operation in a wireless local area network is provided. The mobile communication apparatus comprises a transceiver adapted to communicate data intended for the mobile communication apparatus. Furthermore, the mobile communication apparatus comprises a repeater adapted to receive at least one data packet received by the transceiver, wherein the data packet is intended for another communication device, and forward the data packet via the transceiver to the communication device.

The repeater may be adapted to receive the data packet from a first communication device, the data packet being intended for a second communication device, and determine whether the data packet is to be forwarded to the second communication device based on data packets communicated from the first communication device or from the second communication device.

The repeater may be adapted to determine whether an identifier comprised in the data packet corresponds to a pre-defined identifier stored in the mobile communication apparatus and determine that the data packet is to be forwarded only if the identifier corresponds to the pre-defined identifier. The repeater may be adapted to determine whether a first data packet received by the repeater corresponds to a second data packet received by the repeater, wherein the first data packet is received prior to the second data packet, and determine that the first data packet or the second data packet is to be forwarded only if the first data packet corresponds to the second data packet. The repeater may be adapted to determine whether a second data packet received by the repeater from the second communication device comprises an ACK message (ACKnowledge message) as a response to a first data packet, wherein the first data packet is received from the first communication device prior to the second data packet, and determine that the first data packet is not to be forwarded if the second data packet comprises the ACK message. The repeater may be adapted to determine whether a second data packet received by the repeater from the second communication device comprises a NACK message (Negative-ACKnowledge message) as a response to a first data packet, wherein the first data packet is received from the first communication device prior to the second data packet, and determine that the first data packet is to be forwarded if the second data packet comprises the NACK message.

The mobile communication apparatus may also comprise a power monitoring unit adapted to control the repeater in dependence of a remaining charge of a battery included in the mobile communication apparatus.

The mobile communication apparatus may, for example, be a portable or handheld mobile radio communication device, a mobile radio terminal, a mobile telephone, a cellphone, a pager, a communicator, an electronic organizer, a smartphone, a computer, or a portable computer.

According to a second aspect, a method performed by a mobile communication apparatus for operation in a wireless local area network is provided. The mobile communication apparatus has a transceiver adapted to communicate data intended for the mobile communication apparatus. The method comprises the steps of receiving by means of a repeater at least one data packet received by the transceiver, wherein the data packet is intended for another communication device, and forwarding the data packet by means of the repeater via the transceiver to the communication device.

The step of receiving may comprise receiving the data packet from a first communication device, the data packet being intended for a second communication device, and determining whether the data packet is to be forwarded to the second communication device based on data packets communicated from the first communication device or the second communication device.

The step of determining may comprise determining whether an identifier comprised in the data packet corresponds to a pre-defined identifier stored in the mobile communication apparatus, and determining that the data packet is to be forwarded only if the identifier corresponds to the pre-defined identifier. The step of determining may comprise determining whether a first data packet corresponds to a second data packet, wherein the first data packet is received prior to the second data packet, and determining that the first data packet or the second data packet is to be forwarded only if the first data packet corresponds to the second data packet. The step of determining may comprise determining whether a second data packet received from the second communication device comprises an ACK message as a response to a first data packet, wherein the first data packet is received from the first communication device prior to the second data packet, and determining that the first data packet is not to be forwarded if the second data packet comprises the ACK message. The step of determining may comprise determining whether a second data packet received from the second communication device comprises a NACK message as a response to a first data packet, wherein the first data packet is received from the first communication device prior to the second data packet, and determining that the first data packet is to be forwarded if the second data packet comprises the NACK message.

The method may also comprise controlling the repeater in dependence of a remaining charge of a battery included in the mobile communication apparatus.

According to a third aspect, a computer program product is provided. The computer program product comprises computer program code means for executing the method according to the second aspect, when said computer program code means are run by an electronic device having computer capabilities.

According to a fourth aspect, a computer readable medium is provided. The computer readable medium has stored thereon a computer program product comprising computer program code means for executing the method according to the second aspect, when said computer program code means are run by an electronic device having computer capabilities.

Further embodiments of the invention are defined in the dependent claims.

Embodiments of the invention may allow for an increase of the coverage of a wireless local area network.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Further objects, features and advantages of embodiments of the invention will appear from the following detailed description, reference being made to the accompanying drawings, in which:

FIG. 1 is a schematic view of a local area network including a mobile communication apparatus wirelessly connected to a first and a second communication device;

FIG. 2 is a schematic view of a local area network including three mobile communication apparatuses;

FIG. 3 is a block diagram illustrating an embodiment of a packet configuration of a data packet;

FIG. 4 is a block diagram illustrating some components of an embodiment of a mobile communication apparatus;

FIG. 5 is a block diagram illustrating some components of another embodiment of a mobile communication apparatus; and

FIG. 6 is a flowchart illustrating an embodiment of a method performed by a mobile communication apparatus for operation in a wireless local area network.

FIG. 7 is a flowchart illustrating an embodiment of a method performed by a mobile communication apparatus for operation in a wireless local area network.

### DETAILED DESCRIPTION OF EMBODIMENTS

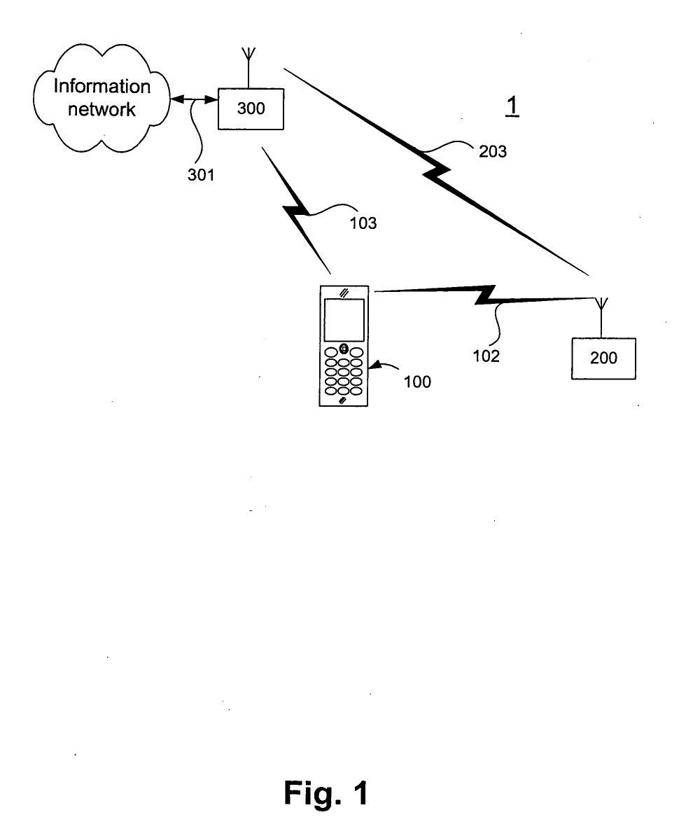

FIG. 1 illustrates a wireless local area network 1 including a mobile communication apparatus 100. The mobile communication apparatus 100 may be adapted to wirelessly communicate, over a link 102, with a first communication device 200 according to a short-range wireless communication standard. Also, the mobile communication apparatus 100 may be adapted to wirelessly communicate, over a link 103, with a second communication device 300 according to a short-range wireless communication standard. Furthermore, a connection 301, which may be an Ethernet connection, a T1 line, a wideband wireless connection or any other electrical connection providing data communications, may be connected to the second communication device 300. Moreover, the first communication device 200 may be adapted to wirelessly communicate, over a link 203, with the second communication device 300 according to a short-range wireless communication standard.

In FIG. 1, the mobile communication apparatus 100 is exemplified as a mobile telephone. However, for convenience and for simplicity of presentation reference will be made to a mobile communication apparatus 100 in the following. This should not be interpreted restrictively, but rather as an example. The mobile communication apparatus 100 may be a portable or handheld mobile radio communication device, a mobile radio terminal, a cellphone, a pager, a communicator, an electronic organizer, a smartphone, or a portable computer. Furthermore, the first communication device 200 may e.g. be a computer (such as a portable computer) or a mobile telephone. Moreover, the second communication device 300 may be an Access Point (AP).

The first and second communication devices 200, 300 may be separated at a distance, which is larger than the maximum transmission length in the wireless local area network 1. Thus, the first communication device 200 and the second communication device 300 may be out-of-range of each other for direct communication over the link 203. Providing a repeater functionality in the mobile communication apparatus 100 may allow for the first communication device 200 to connect wirelessly to the second communication device 300 via the mobile communication apparatus 100, even though the first and second communication devices 200 and 300 are out-of-range for direct communication. The mobile communication apparatus 100 is movable and may be located in between the first and the second communication devices 200, 300. Hence, in comparison to the first communication device 200, the mobile communication apparatus 100 may be located closer to the intended second communication device 300. Accordingly, the mobile communication apparatus 100 may be in a better position to wirelessly connect to the second communication device 300. In other words, providing repeater functionality in the mobile communication apparatus 100 may allow for the provision of an operable wireless link 102-103 between the first and second communication devices 200, 300 via the mobile communication apparatus 100. Consequently, the mobile communication apparatus 100 equipped with the repeater functionality may allow for an enhancement of the coverage of the wireless local area network 1.

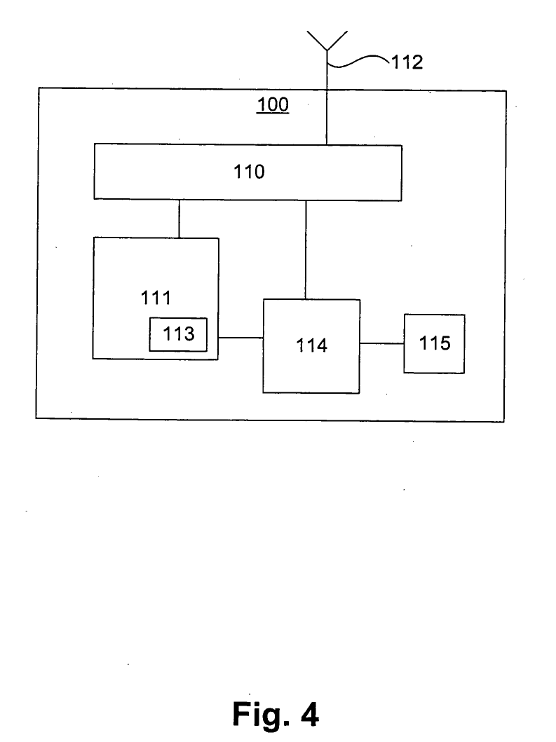

The mobile communication apparatus 100 according to embodiments of the invention comprises a transceiver 110 operatively connected to a repeater 111 (FIG. 4). The transceiver 110 may be adapted to communicate data intended for the mobile communication apparatus 100. Furthermore, the transceiver 110 is adapted to communicate data packets according to one or several short-range wireless communication standards. The short-range wireless communication standard may e.g. be any IEEE 802.11 standard, such as 802.11b (Wi-Fi) or 802.11g (Wi-Fi), or any Bluetooth standard, such as Bluetooth 1.0. Both IEEE 802.11 standards and Bluetooth standards may be used for wireless short-range communication between any of the mobile communication apparatus 100, and the first and second communication devices 200 and 300. The transceiver 110 may be adapted to receive any data packet transmitted from the first communication device 200 intended for the second communication device 300, or vice versa. The transceiver 110 may also, but does not need to, be configured for communication with a mobile telecommunications network according to any communication technology such as GSM, UMTS, CDMA2000, PDS, or PDC.

The repeater 111 is adapted to receive at least one data packet received by the transceiver 110 and forward the data packet via the transceiver 100. The data packet may be a data packet received from the first communication device 200 and being intended for the second communication device 300. The repeater 110 may e.g. be adapted to determine whether the data packet is to be forwarded to the second communication device 200 based on the traffic of data packets transmitted from the first communication device 200 to the intended second communication device 300. Moreover, the repeater 111 may be adapted to forward the data packet via the transceiver 110 to the second communication device 300 if it is determined that the data packet received by the repeater 111 is to be forwarded.

Yet further, the repeater 111 may be adapted to repeatedly forward the data packet until the repeater 111 determines that a data packet received by the repeater 111 includes an ACK from the second communication device 300 as a response to the forwarded data packet. For example, when the repeater 111 has determined that a data packet received by the repeater 111 includes an ACK from the second communication device 300 as a response to the forwarded data packet, it may be possible to establish and maintain a wireless connection 102-103 between the first and second communication devices 200, 300 via the mobile communication apparatus 100.

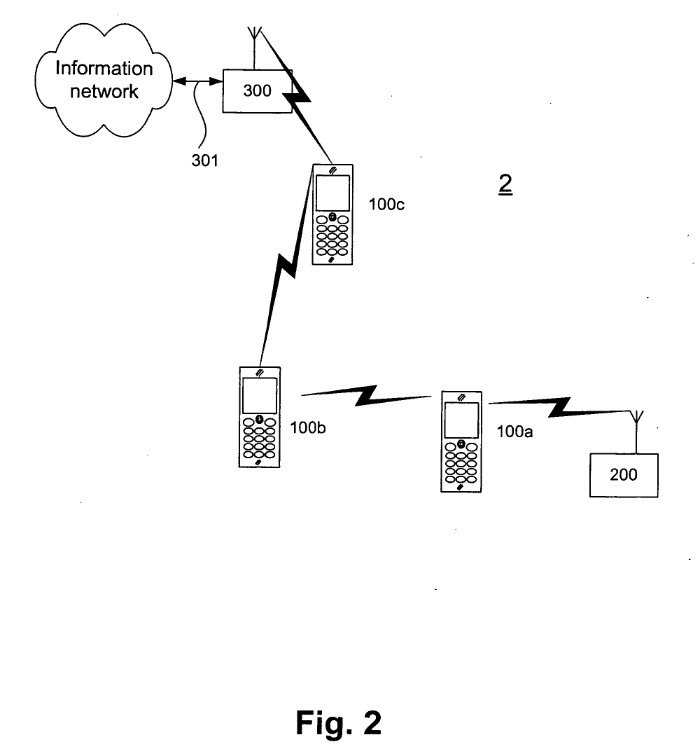

FIG. 2 illustrates a wireless local area network 2 including three mobile communication apparatuses 100a, 10b, 100c. Each of the mobile communication apparatuses 10a, 100b, 100c is adapted to operate in accordance with the description of the mobile communication apparatus 100 hereinabove. It is to be noticed that the respective repeater of the mobile communication apparatuses 100a, 10b, 100c may be adapted to forward a data packet via the respective transceiver either directly to an intended communication device 200, 300 or indirectly to the intended communication device 200, 300 via one or several proximate mobile communication apparatuses 100a, 100b, 10c. Thus, providing repeater functionality in a mobile communication apparatus 100a, 100b, 100c may allow for the first communication device 200 to connect wirelessly to the second communication device 300 via one or more of the mobile communication apparatuses 100a, 100b, 100c. This may be accomplished even though the first and second communication devices 200 and 300 are separated by a relatively large distance. Consequently, several mobile communication apparatuses 100a, 100b, 100c equipped with repeater functionality may allow for an increase of the coverage of the existing wireless local area network 2 over large areas.

It should be noticed that a wireless local area network including several mobile communication apparatuses 100 and/or several communication devices 200, 300 may require collision handling or a mechanism to either prevent collisions of data packets altogether or to recover from collisions when they do occur. This may, for instance, be accomplished according to known principles in accordance with the short-range wireless communication standard utilized in the wireless local area network.

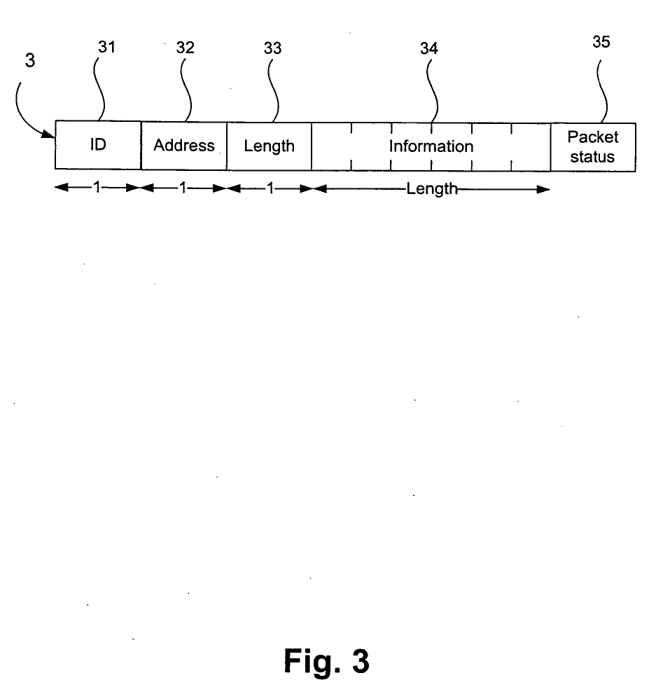

FIG. 3 illustrates an example of a configuration of a data packet that may be communicated between the mobile communication apparatus 100, the first communication device 200, and the second communication device 300 in FIGS. 1 and 2. For example, the data packet may be part of the ongoing WLAN transactions between the mobile communication apparatus 100, the first communication device 200, and the second communication device 300. FIG. 3 shows an example of a configuration of a data packet governed by the above-mentioned short-range wireless communication standards. Note, however, that the data packet shown in FIG. 3 is only one example. It should be appreciated that there are several other data packets embedded in e.g. the 802.11 standard.

The data packet 3 may comprise an ID element 31 for identifying the transmitting communication device 100, 200, 300 of the data packet 3. The ID element 300 may comprise data concerning a subscriber identity of the transmitting communication device 100, 200, 300. Furthermore, the data packet 3 may comprise an address element 32 including information regarding the intended recipient of the data packet 3. Moreover, the data packet 3 may comprise a length element 33 for indicating the variable length of an information element 34. The information element 34 includes information. This information may include speech and/or data. Furthermore, the data packet may comprise a data packet status field 35. The data packet status field 35 may e.g. include data for keeping track of communicated data packets and the corresponding ACKs/NACKs.

FIG. 4 illustrates certain components, which may be integrated in a mobile communication apparatus 100 described above with reference to FIGS. 1 and 2. The mobile communication apparatus comprises a transceiver 110 operatively connected to a repeater 111. The transceiver may be operatively connected to an antenna 112. The repeater 111 may comprise a memory device 113. Moreover, the repeater 111 may be operatively connected to a processor 114, which may e.g. be a Central Processing Unit (CPU). The processor 114 may be operatively connected to the transceiver 110. Furthermore, the processor may be operatively connected to a memory unit 115. The repeater 111 and the processor 114 are shown as separate units in FIG. 4. However, a CPU could alternatively provide the repeater 111 by running software designed for performing the functions of the repeater 111.

The transceiver 110 may be configured to include an 802.11-transceiver. Additionally, or alternatively, the transceiver 110 may be configured to include a Bluetooth transceiver. The transceiver 110 may thus be adapted to communicate data packets (FIG. 3), via the antenna 112, according to one or more of the short-range wireless communication standards mentioned above, e.g. IEEE 802.11 standards or Bluetooth standards. The transceiver 110 may be adapted to listen to or sense the traffic of data packets transmitted from the first and second communication devices 200 and 300 (FIG. 1). Accordingly, the transceiver 110 may be adapted to detect any data packets that are transmitted between the first and second communication devices 200 and 300. Furthermore, the transceiver 110 is adapted to receive any data packets from the first communication device 200 intended for the second communication device 300. Similarly, the transceiver 110 is adapted to receive any data packets from the second communication device 300 that are intended for the first communication device 200.

The transceiver 110 is operatively connected to the repeater 111. The repeater 111 may be adapted to receive at least one data packet received by the transceiver 110. Consequently, the repeater 111 may be adapted to receive any data packet from the first communication device 200 intended for the second communication device 300, or vice versa. Furthermore, the repeater 111 may comprise a memory device 113 for temporarily storing any received data packet. The memory device 113 may be adapted to only store data packets intended for use of the repeater 111. Data intended for the mobile communication apparatus 100 itself may be stored in another memory unit, e.g. memory unit 115, of the mobile communication apparatus 100. Providing a memory device 113 within the repeater 111 in which only content not intended for the mobile communication apparatus 100 may be stored may e.g. allow for a mobile communication apparatus 100 with low risk for intrusion of e.g. viruses.

Furthermore, the repeater 111 may be adapted to forward the at least one received data packet via the transceiver 110. The forwarding of the at least one data packet may comprise repeating or re-generating the at least one received data packet. The repeater 111 may be adapted to determine whether any received data packet is to be forwarded. For example, the repeater 111 may be adapted to receive from the first communication device 200 a data packet intended for the second communication device 300, and determine whether this data packet is to be forwarded to the intended second communication device 300 based on data packets communicated from the first communication device 200 or from the second communication device 300.

The determination of whether any received data packet is to be forwarded or not performed by the repeater 111 may be accomplished in different ways. In one embodiment, the repeater 111 is adapted to determine whether the ID element 31 of a received data packet 3 corresponds to a pre-defined ID element. The pre-defined ID element may be pre-loaded or stored in the memory device 113 of the repeater 111. Alternatively, a pre-defined ID element may be pre-loaded or stored in another memory unit, e.g. memory unit 115, comprised in the mobile communication apparatus 100. The repeater 111 may be adapted to determine that a received data packet is to be forwarded only when it is determined that the ID element 31 of the received data packet corresponds to a pre-defined ID element. Thus, the repeater 111 may be adapted to selectively forward data packets to an intended communication device 200, 300. This may e.g. allow for the user of a mobile communication apparatus 100 to pre-define rules for which data packets to forward. As one example, in a home environment the user could select that only data packets from communication devices authorized by the user should be forwarded. As another example, in an office environment the user could authorize that only data packets from communication devices managed by colleagues in the user's organization should be forwarded. Having pre-defined rules for which data packets to forward may allow for minimizing the total traffic of data packets within a local area network. Furthermore, this may allow for reducing the total power consumption necessary for forwarding data packets.

In an embodiment, the repeater 111 is adapted to determine whether a first data packet received by the repeater 111 corresponds to a second data packet received by the repeater 111, where the first data packet is received prior to the second data packet. In this embodiment, the repeater 111 may thus be adapted to compare two data packets received at different instants of time. The repeater 111 may be adapted to determine that the first data packet or the second data packet is to be forwarded only if the first data packet corresponds to the second data packet. The repeater 111 may thus be adapted to forward data packets to an intended communication device only when necessary. For example, if the first communication device 200 retries to send the same data packet one or more times for establishing a wireless link with the second communication device 300, the repeater 111 according to this embodiment may be capable of determining that corresponding data packets have been transmitted to the intended second communication device 300 several times. Accordingly, the repeater 111 may receive at least a first data packet and a second data packet, respectively. The first and the second data packet would be identical. Then, the repeater 111 would be capable of determining that the first data packet corresponds to the second data packet. Hence, the first data packet or the second data packet would be forwarded to the intended second communication device 300. The forwarding of the first data packet or the second data packet may e.g. be accomplished after a pre-defined number of retries by the first communication device 200. Forwarding a data packet only when the first communication device 200 has retried to connect wirelessly to an intended second communication device 300 one or more times may allow for minimizing the total traffic of data packets within a local area network.

In an embodiment, the repeater 111 is adapted to determine whether a second data packet received by the repeater comprises an ACK from the second communication device 300 as a response to a first data packet. Note that the first data packet is received from the first communication device 200 before the second data packet is received from the second communication device 300. Furthermore, in this embodiment the repeater 111 is adapted to determine that the first data packet is not to be forwarded if the second data packet comprises the ACK. In other words, the repeater 111 is adapted to refrain from forwarding an initially received data packet received from the first communication device 200 if it is determined that a subsequent data packet received later from the second communication device 300 comprises an ACK as a response to the initially received data packet. For example, if the first communication device 200 receives a data packet comprising an ACK from the second communication device 300 it is determined that the first communication device 200 may establish and maintain a wireless link with the second communication device 300. Thus, it is not necessary forward any received data packet. Similar to the previous embodiment, this embodiment may allow for the provision of a mobile communication apparatus 100 that is adapted to forward data packets to an intended communication device only when necessary.

In an embodiment, the repeater 111 is adapted to determine whether a second data packet received by the repeater comprises an NACK from the second communication device 300 as a response to a first data packet. Note that the first data packet is received from the first communication device 200 before the second data packet is received from the second communication device 300. Furthermore, in this embodiment the repeater 111 is adapted to determine that the first data packet is to be forwarded if the second data packet comprises the NACK. For example, if the first communication device 200 has been successful in establishing a wireless connection over link 203 with the second communication device 300 (FIG. 1), the wireless connection 203 may even so be relatively bad, for example, due to the fact that the first and second communication devices 200, 300 are separated are separated from each other at a distance which is substantially equal to or slightly above the maximum transmission length in the wireless local area. In this example, the second communication device 300 would transmit a NACK message to the first communication device 200, thus informing the first communication device 200 that the wireless connection is relatively bad. When the repeater 111 receives the NACK from the second communication device 300 as a response to the first data packet, the repeater is capable of determining that the earlier received first data packet should be forwarded to the intended second communication device. Compared to the first communication device 200, the mobile communication apparatus 100 may be located closer to the intended second communication device 300. Thus, the mobile communication apparatus 100 may be in a better position to wirelessly connect to the second communication device 300.

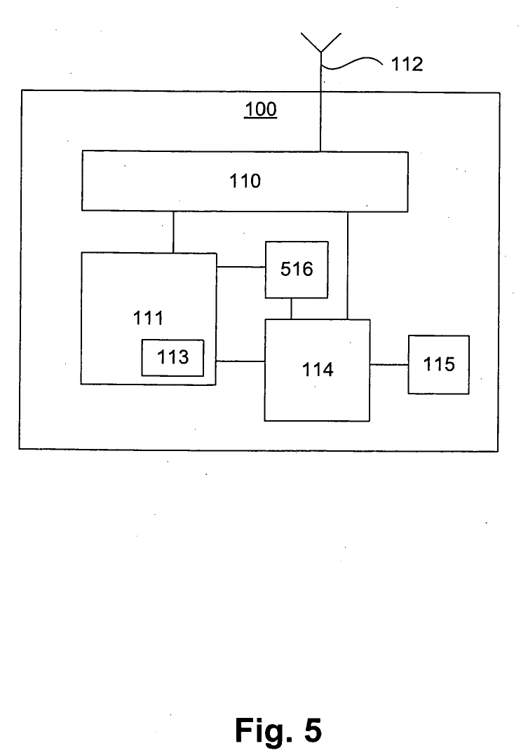

FIG. 5 illustrates another embodiment of the mobile communication apparatus 100. Besides what is described below with reference to FIG. 5, the elements of FIG. 5 having corresponding reference signs in FIG. 4 may operate and interact similarly to the description with reference to FIG. 4. The mobile communication apparatus 100 of FIG. 5 differs from the mobile communication apparatus 100 described with reference to. FIG. 4 in that it further includes a power monitoring unit 516. The power monitoring unit 516 may be configured to monitor the remaining charge of a battery (not shown) included in the mobile communication apparatus 100. The obtaining of the remaining charge of the battery may be accomplished according to known principles and will not be further explained here. As is illustrated in FIG. 5, the repeater 111 may be operatively connected to the power monitoring unit 516. The power monitoring unit 516 may be adapted to control the repeater 111 in dependence of the remaining charge of the battery. Thus, forwarding of a data packet may e.g. be performed only when the remaining charge of the battery is above a certain pre-defined level. Forwarding any received data packet to an intended communication device only when the remaining power in the battery is over a pre-defined value may provide for the avoidance of draining the battery.

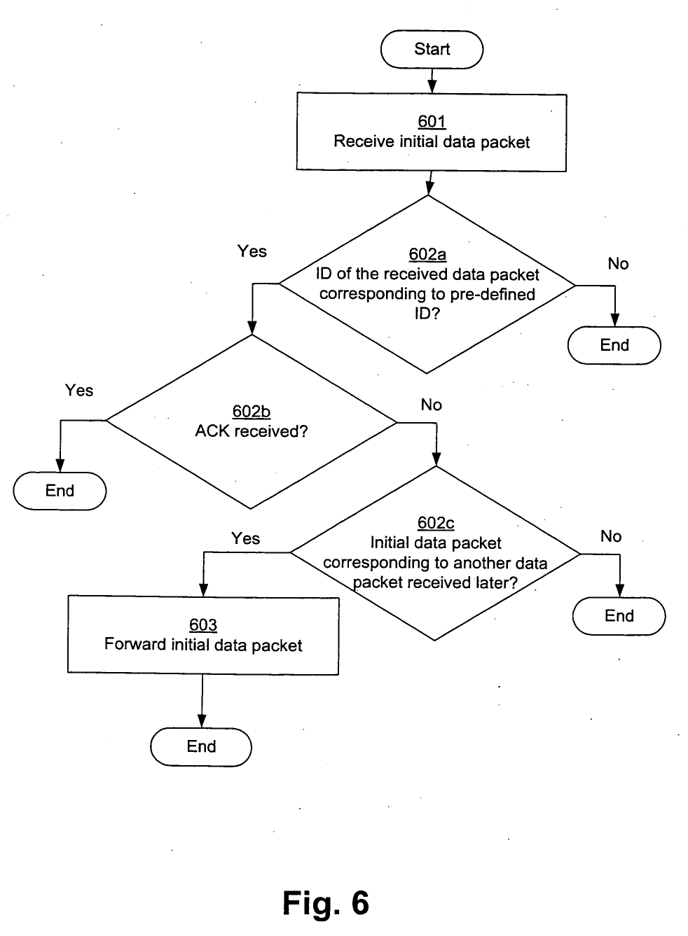

FIG. 6 illustrates an embodiment of a method performed by a mobile communication apparatus 100 suitable for operation in a wireless local area network. The mobile communication apparatus 100 comprises a transceiver 110 adapted to communicate data intended for the mobile communication apparatus 100. In step 601, a first initial data packet that has been received by the transceiver 110 is received by means of a repeater 111 of the mobile communication apparatus. The initial data packet may e.g. be received from a first communication device 200 and being intended for a second communication device 300. In step 602, it is determined whether the initially received data packet is to be forwarded to the second communication device 300 or not. The determination in step 602 may be based on data packets communicated from the first communication device 200 or from the second communication device 300.

In step 602a, it is determined whether an identifier comprised in the initially received data packet corresponds to a pre-defined identifier that is stored in the mobile communication apparatus 100. If the identifier comprised in the received data packet does not correspond to a pre-defined identifier, the procedure is ended. If the identifier comprised in the received data packet corresponds to a pre-defined identifier, the procedure proceeds to step 602b. In step 602b, it is determined whether a second data packet comprises an ACK from the second communication device 300 as a response to the initial data packet. It is to be noted that the initial data packet is received from the first communication device 200 before the second data packet is received from the second communication device 300. If it is determined that the second data packet comprises the ACK it is also determined that the initial data packet is not to be forwarded to the second communication device. If so, the procedure is ended. If it is determined that the second data packet does not comprise any ACX, the procedure proceeds to step 602c. In step 602c, it is determined whether the initial data packet corresponds to a second data packet, wherein the initial data packet has been received prior to the second data packet. Hence, the initially received data packet is compared with another data packet received later. In step 602c, it may also be determined that the initial data packet is to be forwarded only if the initially received data packet corresponds to another data packet that has been received later. If the initially received data packet does not correspond to another data packet that has been received later, the procedure is ended. However, if it is determined in step 602c that the initial data packet is to be forwarded, the procedure proceeds to step 603. In step 603, the initial data packet may be forwarded by means of the repeater 111 via the transceiver 110 to the second communication device 300. In one embodiment, the step of forwarding in step 603 may be performed in dependence of the remaining charge of a battery included in the mobile communication apparatus.

Not all steps illustrated in FIG. 6 are necessary for carrying out the method according to embodiments of the invention. For example, step 602a is not necessary in all embodiments as the determination of whether a received data packet is to be forwarded may e.g. be applied by one or more of the steps 602b and 602c without carrying out step 602a. It should be appreciated that the method steps 602a, 602b, and 602c, respectively, may be varied in different combinations for carrying out the determination of whether a received data packet is to be forwarded.

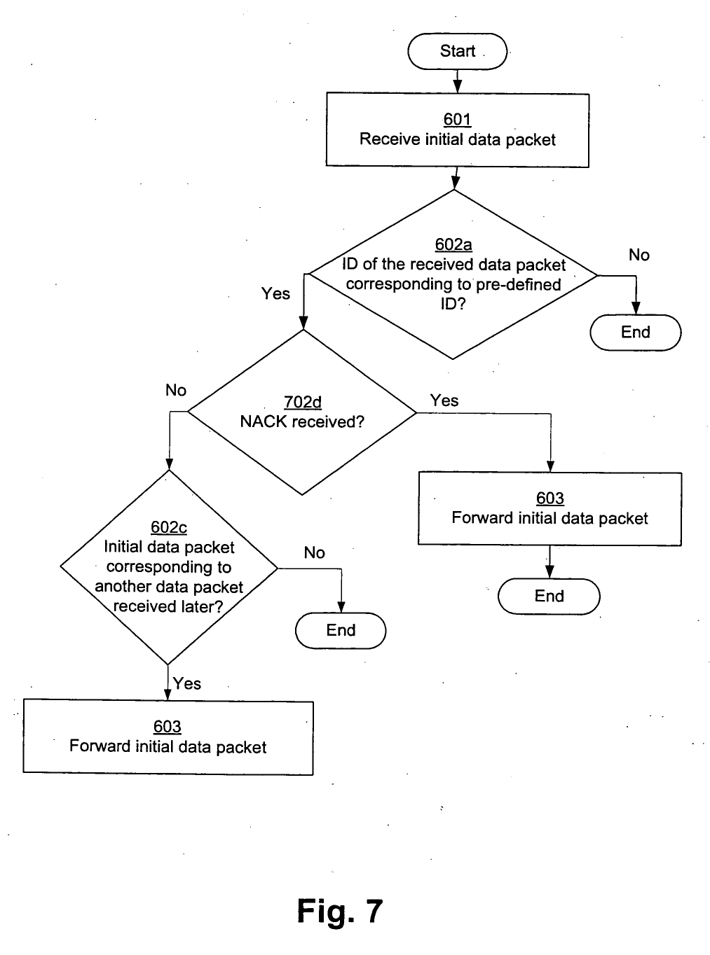

FIG. 7 illustrates an embodiment of a method performed by a mobile communication apparatus 100 suitable for operation in a wireless local area network. Besides what is described below with reference to FIG. 7, the steps of FIG. 7 having corresponding reference signs in FIG. 6 may be carried out similarly to the description with reference to FIG. 6. The method shown in FIG. 7 differs from the method described with reference to FIG. 6 in that it includes a step 702d. In step 702d, it is determined whether a second data packet comprises a NACK from the second communication device 300 as a response to the initial data packet, whereby the initial data packet has been received from the first communication device 200 before the second data packet is received from the second communication device 300. If it is determined that the second data packet comprises the NACK, the procedure may continue to step 603. If it is determined that the second data packet does not comprise the NACK, the procedure may continue to step 602c.

Not all steps illustrated in FIG. 7 are necessary for carrying out the method according to embodiments of the invention. For example, step 602a is not necessary in all embodiments as the determination of whether a received data packet is to be forwarded may e.g. be applied by one or more of the steps 702d and 602c without carrying out step 602a. It should be appreciated that the method steps 602a, 702d, and 602c may be varied in different combinations for carrying out the determination of whether a received data packet is to be forwarded.

The present invention may be embedded in a computer program product, which enables implementation of the method and functions described herein. The invention may be carried out when the computer program product is loaded and run in a system having computer capabilities. Computer program, software program, program product, or software, in the present context mean any expression, in any programming language, code or notation, of a set of instructions intended to cause a system having a processing capability to perform a particular function directly or after conversion to another language, code or notation.

Embodiments of the present invention may allow for an extension of an existing wireless local area network. A mobile communication apparatus, such as a mobile telephone, equipped with a repeater according to embodiments of the invention may hence extend the range of an existing wireless local area network. Furthermore, implementing a repeater into the mobile communication apparatus 100 may allow for utilizing the existing transceiver of the mobile communication apparatus 100. The additional manufacturing costs of implementing the repeater in the mobile communication apparatus 100 may be relatively low. Furthermore, a synergy effect can be obtained in that the mobile communication apparatus 100 can be used not only for its specific purpose but also at the same time act as an extension of an existing wireless local area network. Moreover, a repeater implemented in a mobile communication apparatus may allow for a temporary extension of an existing wireless local area network. The functionality of the repeater may be used in mobile communication apparatuses for operation in a wireless local area network in e.g. a public place, etc. When several mobile communication apparatus having repeater functionality according to embodiments of the invention are located in such a public place, they may together allow for the provision of a virtual wireless local area network by forwarding data packets to each other. This may allow for an extension of the existing wireless local area network over large areas. Moreover, embodiments of the invention may allow for the extension of an existing wireless local area network without installing additional access points. Accordingly, no additional network investment is required for extending the range of the wireless local area network.

The present invention has been described above with reference to specific embodiments. However, other embodiments than the above described are equally possible within the scope of the invention. Different method steps than those described above, performing the method by hardware or software or a combination of hardware and software, may be provided within the scope of the invention. The different features and steps of the invention may be combined in other combinations than those described. The scope of the invention is only limited by the appended patent claims.

What is claimed is:

1. A mobile communication apparatus for operation in a wireless local area network, comprising:
a transceiver adapted to communicate data intended for the mobile communication apparatus; and
a repeater adapted to receive at least one data packet received by the transceiver, the data packet being intended for another communication device, and forward the data packet via the transceiver to the communication device.

2. The mobile communication apparatus of claim 1, wherein the repeater is adapted to receive the data packet from a first communication device, the data packet being intended for a second communication device, and determine whether the data packet is to be forwarded to the second communication device based on data packets communicated from the first communication device or the second communication device.

3. The mobile communication apparatus of claim 2, wherein the repeater is adapted to determine whether an identifier comprised in the data packet corresponds to a pre-defined identifier stored in the mobile communication apparatus and determine that the data packet is to be forwarded only if the identifier corresponds to the pre-defined identifier.

4. The mobile communication apparatus of claim 2, wherein the repeater is adapted to determine whether a first data packet received by the repeater corresponds to a second data packet received by the repeater, wherein the first data packet is received prior to the second data packet, and determine that the first data packet or the second data packet is to be forwarded only if the first data packet corresponds to the second data packet.

5. The mobile communication apparatus of claim 2, wherein the repeater is adapted to determine whether a second data packet received by the repeater from the second communication device comprises an acknowledge message as a response to a first data packet, wherein the first data packet is received from the first communication device prior to the second data packet, and determine that the first data packet is not to be forwarded if the second data packet comprises the acknowledge message.

6. The mobile communication apparatus of claim 2, wherein the repeater is adapted to determine whether a second data packet received by the repeater from the second communication device comprises a negative-acknowledge message as a response to a first data packet, wherein the first data packet is received from the first communication device prior to the second data packet, and determine that the first data packet is to be forwarded if the second data packet comprises the negative-acknowledge message.

7. The mobile communication apparatus of claim 1, further comprising a power monitoring unit adapted to control the repeater in dependence of a remaining charge of a battery included in the mobile communication apparatus.

8. The mobile communication apparatus of claim 1, wherein the mobile communication apparatus comprises at least one of a portable or handheld mobile radio communication device, a mobile radio terminal, a mobile telephone, a cellphone, a pager, a communicator, an electronic organizer, a smartphone, a computer, and a portable computer.

9. A method performed by a mobile communication apparatus for operation in a wireless local area network, the mobile communication apparatus having a transceiver adapted to communicate data intended for the mobile communication apparatus, comprising the steps of:
receiving via a repeater at least one data packet received by the transceiver, the data packet being intended for another communication device; and
forwarding the data packet via the repeater and the transceiver to the communication device.

10. The method of claim 9, wherein the step of receiving comprises:
receiving the data packet from a first communication device, the data packet being intended for a second communication device; and
determining whether the data packet is to be forwarded to the second communication device based on data packets communicated from the first communication device or the second communication device.

11. The method of claim 10, wherein the step of determining comprises:
determining whether an identifier comprised in the data packet corresponds to a pre-defined identifier stored in the mobile communication apparatus; and
determining that the data packet is to be forwarded only if the identifier corresponds to the pre-defined identifier.

12. The method of claim 10, wherein the step of determining comprises:
determining whether a first data packet corresponds to a second data packet, wherein the first data packet is received prior to the second data packet; and
determining that the first data packet or the second data packet is to be forwarded only if the first data packet corresponds to the second data packet.

13. The method of claim 10, wherein the step of determining comprises:
determining whether a second data packet received from the second communication device comprises an acknowledge message as a response to a first data packet, wherein the first data packet is received from the first communication device prior to the second data packet; and
determining that the first data packet is not to be forwarded if the second data packet comprises the acknowledge message.

14. The method of claim 10, wherein the step of determining comprises:
determining whether a second data packet received from the second communication device comprises a negative-acknowledge message as a response to a first data packet, wherein the first data packet is received from the first communication device prior to the second data packet; and
determining that the first data packet is to be forwarded if the second data packet comprises the negative-acknowledge message.

15. The method of claim 9, further comprising: controlling the repeater in dependence of a remaining charge of a battery included in the mobile communication apparatus.

16. A computer program product comprising computer program code that is configured to carry out the method according to claim 9 when executed by an electronic device.

17. A computer program product comprising computer program code that is configured to carry out the method according to claim 12 when executed by an electronic device.

18. A computer readable medium having stored thereon a computer program product comprising computer program code that is configured to carry out the method according to claim 9 when executed by an electronic device.

19. A computer readable medium having stored thereon a computer program product comprising computer program code that is configured to carry out the method according to claim 10 when executed by an electronic device.

20. A computer readable medium having stored thereon a computer program product comprising computer program code that is configured to carry out the method according to claim 15 when executed by an electronic device.
